(19) United States
(12) Patent Application Publication
(10) Pub. No.: US 2007/0253676 A1
(43) Pub. Date: Nov. 1, 2007

(54) Method of controlling recording of program

(75) Inventor: Seung Phil Roh, Pajoo-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/790,252

(22) Filed: Apr. 24, 2007

(30) Foreign Application Priority Data
Apr. 25, 2006 (KR) 10-2006-0036963

(51) Int. Cl. H04N 5/91

(52) U.S. Cl. 386/94

(57) ABSTRACT

Disclosed herein are a method of controlling the recording of a program and a program playing and recording apparatus. In an embodiment of the present invention, a program recording/playing apparatus is assigned a right to record an anti-copy program after performing user authentication, changes the anti-copy program to a copy-once program using the right to record, records the changed copy-once program on a storage medium, and transmits information about the recorded program to a server so that fees corresponding to the recording can be processed in the server. The right to record is an encryption code that is generated based on identification information of the apparatus. The anti-copy program is scrambled through the encryption code and recorded on a storage medium, and the anti-copy program recorded on the storage medium is played using the encryption code.

### BACKGROUND OF THE INVENTION

1. Field of the Invention

The present invention relates generally to a method of controlling the recording of a program and, more particularly, to a method of recording an anti-copy program into a storage medium.

2. Description of the Related Art

Recently, the number of types of broadcasting, such as terrestrial digital broadcasting, satellite digital broadcasting and cable broadcasting, is increasing, and the number of channels provided by each type of broadcasting is rapidly increasing. Such channels include free channels and paid channels for which additional fees must be paid for viewing and listening.

Programs provided through a paid channel are scrambled and then transmitted to control the viewing and listening of the program. Therefore, in order to view and listen to the channel, the setting of a broadcasting receiver or a set-top box must be changed, either automatically or manually.

Furthermore, recently, Personal Video Recorders (PVRs), that is, digital recording devices capable of recording broadcast programs on a storage medium, have been widely popularized. Digital video apparatuses, such as an optical disk recording device equipped with a tuner, can convert broadcast programs of specific periods of time into digital data and record the converted data on/in a built-in hard disk, an optical disk, non-volatile memory, or the like.

Users of such digital video apparatuses may wish to record programs broadcast via broadcasting channels in order to view and listen to the programs at a later time or to play the programs in desired patterns through various playback methods, such as fast playback, slow playback and repeated playback.

Via such a broadcasting channel, a copy-never program, that is, a program that may be viewed but cannot be recorded, or a copy-once program, that is, a program that can be copied once, may be provided. The programs the copying of which is restricted are mainly digital video content that requires copyright protection.

Digital video apparatuses that have acquired copyright authentication, such as Digital Rights Management (DRM) authentication, include Conditional Access Systems (CASs), and, through the CASs, do not record the above-described programs or convert the above-described programs into non-copyable programs, and then record the non-copyable programs on storage media.

However, users of digital video apparatuses, who do not understand the above-described functionality exactly, maybe confused by the situation when programs broadcast via broadcasting channels are not recorded. Furthermore, the situation in which users cannot use VHS videos or DVD titles containing anti-copy programs in their residential areas, that is, the case in which corresponding titles are rented or sold, may occur.

### SUMMARY OF THE INVENTION

Accordingly, the present invention has been made keeping in mind the above problems occurring in the prior art, and an object of the present invention is to provide a method of recording an anti-copy program in a recordable digital video apparatus.

In order to accomplish the above object, the present invention provides a method of controlling recording of a program, comprising the steps of being assigned a right to record an anti-copy program after performing user authentication; changing the anti-copy program to a copy-once program using the right to record, and recording the copy-once program on a storage medium; and transmitting information about the recorded program to a server so that fees corresponding to the recording can be processed in the server.

In an embodiment of the present invention, the right to record may include an encryption code based on the identification information of a recording apparatus, and the encryption code may be generated and provided by the server.

In an embodiment of the present invention, the identification information of a recording apparatus to which the right to record will be assigned may be transmitted via a broadcast signal of the anti-copy program or a broadcast signal of a channel via which the anti-copy program is provided, and the recording apparatus may generate an encryption code corresponding to the right to record based on the identification information.

In the above embodiments, the identification information may be a smart card number mounted in the apparatus, or may be a serial number of the apparatus. Meanwhile, the anti-copy program may be scrambled through the encryption code and recorded on a storage medium, and the anti-copy program recorded on the storage medium may be played using the encryption code.

In an embodiment of the present invention, the right to record may be assigned for a validity period, and the validity period may not be applied to playing of a program recorded based on the right to record. Furthermore, the validity period may be extended through communication with the server.

In an embodiment of the present invention, the information about the recorded program may be transmitted whenever recording of the corresponding program is terminated, or may be transmitted along with information about other recorded programs on a specific date.

In an embodiment of the present invention, the storage medium may comprise at least one of a hard disk, an optical disk and flash memory. Meanwhile, when the anti-copy program is recorded in a detachable storage medium, a separation type medium content protection technology may be further applied to the recording.

Additionally, the present invention provides a program playing and recording apparatus, including a storage medium for storing a program; a recording/playing unit for recording or playing a program; a communication interface unit connected to an external server; and a controller for controlling the communication interface unit so as to perform a user authentication procedure with the server, the play/recording unit so as to change an anti-copy program to a copy-once program based on an assigned right to record an anti-copy program and to record the resulting program on the storage medium, and the communication interface unit so as to transmit information about the recorded program so that fees corresponding to the recording can be processed in the server in a case where the anti-copy program is recorded.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating an embodiment in which a video apparatus and a content providing server are connected via a network according to the present invention; and

FIG. 2 is a flowchart illustrating a method of controlling the recording of a program according to the present invention.

### DETAILED DESCRIPTION OF PREFERRED EMBODIMENTS

The present invention will be described in detail in connection with a preferred embodiment, with reference to the accompanying drawings.

A paid channel or a paid program, which can be viewed and listened to upon payment, may be referred to as a “Pay-Per-View (PPV) channel or program,” and a program which can be limitedly recorded upon payment, and the copyright of which is protected, may be referred to as a “Pay-Per-Copy (PPC) program.”

PPV channels operate in environments of wired broadcasting, cable broadcasting, satellite broadcasting, etc. based on the resolution of technical problems, such as the assignment of viewing and listening rights, the restriction of the rights, the charging of fees, etc. for the paid channels. PPV programs, such as a Video on Demand (VoD) program, are provided in an Internet Protocol Television (IP-TV) system, etc.

The present invention is intended to provide a method of recording an anti-copy program on a storage medium, which is built in to or detachably attached to a recordable video apparatus, while protecting the copyright thereof, based on the resolution of technical problems thereof, such as the charging of fees and the restriction of recording.

In the present invention, in order to allow an anti-copy program to be recorded on a storage medium, a copy-never program is converted into a copy-once program after user authentication and payment system contract procedures have been performed.

A method of controlling the recording of programs according to the present invention may be applied to a content play/record device or to a video apparatus, which can receive various types of digital broadcasts, such as terrestrial digital broadcasts, satellite digital broadcasts and cable broadcasts, directly through a tuner or a set-top box, and can record a program having a size smaller than a size corresponding to a specific period of time on a storage medium, such as a hard disk or an optical disk. A video apparatus or content play/record device according to the present invention is equipped with a communication interface that supports connection to a payment system, which is necessary in order to record an anti-copy program.

Therefore, the present invention may be applied to devices equipped with broadcasting reception functionality and network functionality, such as a TV, an optical disk recording device (for example, a DVD recorder), a Digital Multimedia Broadcast (DMB) player, a mobile communication terminal and a Portable Multimedia Player (PMP).

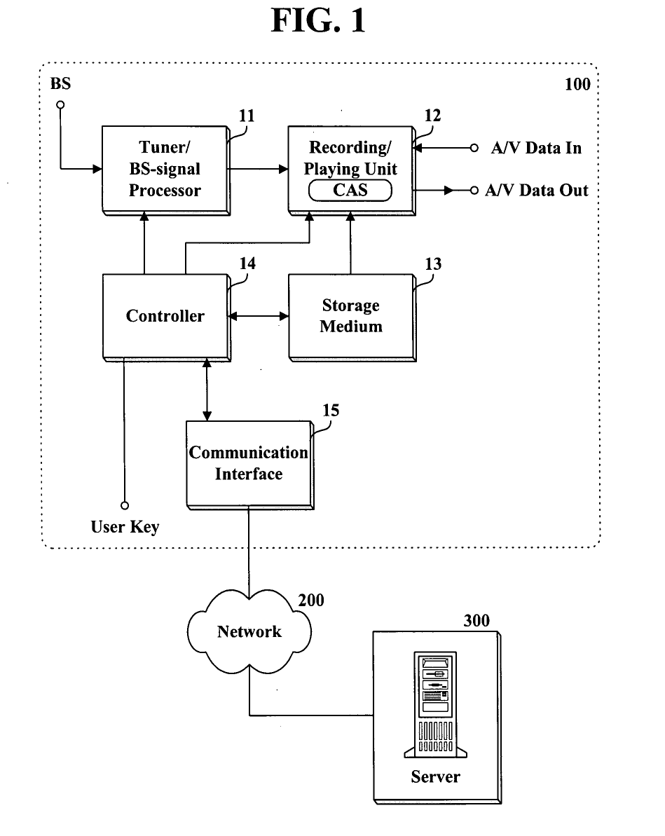

A video apparatus 100 to which the present invention may be applied, as illustrated in FIG. 1, may include a tuner/Broadcast signal (BS) processor 11, a recording/playing unit 12, a storage medium 13, a controller 14, and a communication interface 15. The recording/playing unit 12 may include a Conditional Access System (CAS) for processing the assignment/restriction of rights to view and listen, the assignment/restriction of rights to record, decryption, etc.

The CAS is a system for assigning or restricting rights to view and listen to paid broadcasts. The CAS is a technique in which, when a broadcasting provider encrypts broadcast content based on a reception-restricted encryption technique and transmits the encrypted content via a cable, a satellite, terrestrial waves, the Internet, or the like, a receiving side pays fees, is assigned a right to decrypt a password, and then uses a paid channel or program (for example, a receiving side may purchase a smart card containing an encryption code, and then use the channel or program). Furthermore, the CAS may be applied to a video apparatus having passed copyright-related authentication, and may control the play/record module of the video apparatus so that an anti-copy program can be played but cannot be recorded on a storage medium.

Therefore, in the present invention, a recording-related function is added to the CAS, so that the CAS allows an anti-copy program to be recorded on a storage medium within a video apparatus only when the right to record the anti-copy program is assigned. For this purpose, the CAS, having been assigned the right to record, controls the play/record module, so that the anti-copy program can be recorded on the storage medium, with the attribute of the anti-copy program transmitted through a broadcast signal being changed and the anti-copy program being prevented from being copied to another storage medium, and the anti-copy program recorded on the storage medium can be played back.

Furthermore, the video apparatus 100 constructed as described above may be connected to a server 300 through a network 200 such as the Internet. For example, a content providing server, which is operated by a broadcasting station that provides copy-never programs or copy-once programs, or one of various types of servers, which provide related information, may be used as the server 300.

Furthermore, the server 300 assigns a decryption code for viewing and listening to a paid channel or program, which has been scrambled in order to restrict viewing and listening, or assigns the right to record an anti-copy program, which is provided via digital broadcasting, on the storage medium 13 within the video apparatus 100, through communication with the video apparatus 100.

The controller 14 of the video apparatus 100 controls the operation of the CAS based on the decryption code provided by the server 300, so that the decryption of the scrambled paid channel can be performed normally.

Furthermore, the controller 14 controls the operation of the CAS and the recording/playing unit 12 based on the right to record the anti-copy program received from the server 300, so that the attribute of the program is changed to ‘copy once’ and the program is then recorded on the storage medium 13, with the result that the program recorded on the storage medium 13 has a copy-never attribute.

Furthermore, the controller 14 controls the communication interface 15 so that information about the anti-copy program, recorded on the storage medium 13, is transmitted to the server 300, and then a corresponding fee charging procedure can be performed. This is described in detail below.

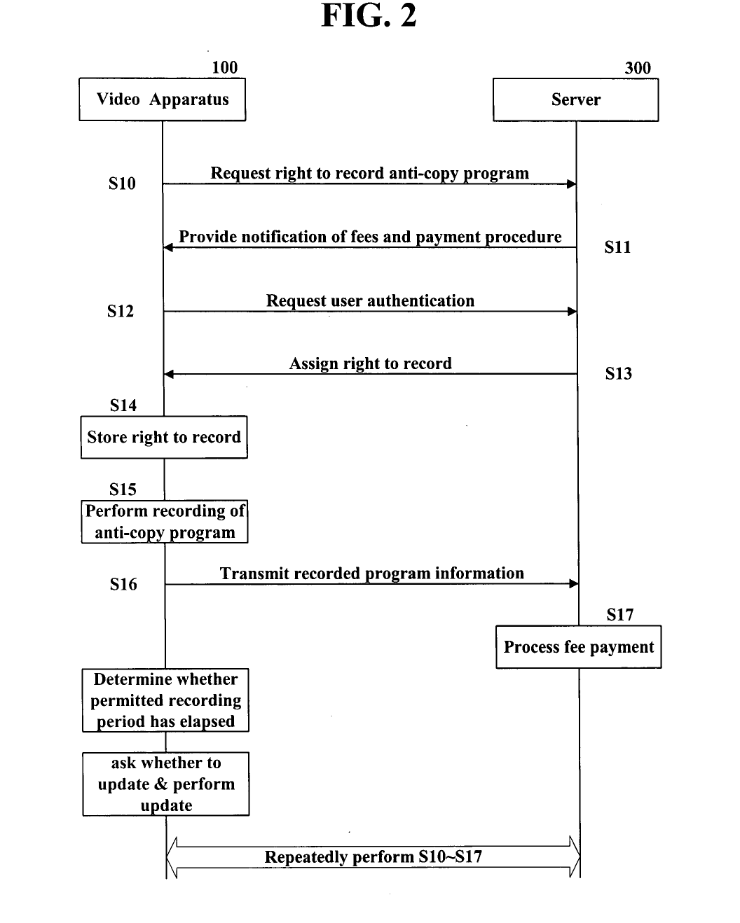

FIG. 2 is a flowchart illustrating a method of controlling the recording of a program according to the present invention.

If a user requests the recording of an anti-copy program, the controller 14 of the video apparatus 100 connects with the server 300 by controlling the operation of the communication interface 15, and then requests the server 300 to assign the right to record the anti-copy program at step S10.

The server 300 transmits a message, providing notification of a preset fee processing and payment procedure, etc., to the video apparatus 100 in response to the request for the right to record at step S11. The controller 14, having received the message, generates a guide message corresponding to the message, and displays it on the external display window or screen thereof.

Furthermore, the controller 14 requests user authentication by controlling the communication interface 15 according to a user's selection at step S12. If the user authentication procedure is performed normally, the server 300 assigns the right to record the anti-copy program at step S13.

The recording right assigned by the server 300 may have, for example, an encryption code form. The video apparatus 100 transmits unique identification information, capable of identifying itself, such as an ID, a serial number, or a smart card number associated with the CAS operation, to the server 300 at the time of requesting the right to record at step S10 and/or requesting user authentication at step S12. Then, the server 300 may generate an encryption code using the identification information, and assign the right to record by transmitting the encryption code to the video apparatus 100.

The controller 14 stores the encryption code, received from the server 300, on the storage medium 13 or in non-volatile memory within the video apparatus 100 so that the recording of the anti-copy program and the playback of the recorded anti-copy program can be controlled through the CAS within the recording/playing unit 12 at step S14.

The controller 14 then controls the operation of the CAS based on the encryption code so that the attribute of the anti-copy program is changed to ‘copy once,’ and controls the recording/playing unit 12 so that the program, the attribute of which has been changed to ‘copy once,’ is recorded on the storage medium 13 at step S15.

In this case, when recording the anti-copy program on the storage medium 13 through the recording/playing unit 12, the CAS scrambles the anti-copy program using the encryption code, or modifies the program so that it cannot be played without using the encryption code.

Furthermore, since the encryption code has been generated based on the identification information of the video apparatus 100, the anti-copy program recorded on the storage medium 13 cannot be played in other devices even if the encryption code is leaked.

An optical disk, a hard disk, flash memory or the like may be used as the storage medium 13. In the case where a detachable medium, such as flash memory or an optical disk, is used, Content Protection for Removable Media (CPRM), that is, separation-type medium content protection technology, may be further used.

Furthermore, in the case where the anti-copy program is recorded, the controller 14 transmits information about the recorded program, such as a broadcast program ID and/or a program name, to the server 300 at step S16. The controller 14 may transmit information about a recorded program whenever the recording of the program is terminated, or may collect and transmit information about one or more recorded programs on a specific date. The controller 14 also transmits the identification information of the video apparatus 100 when transmitting the information about the recorded program.

The server 300 performs a corresponding fee charging and payment procedure with reference to the broadcast program ID and/or the program name received from the video apparatus 100 at step S17. The fees may be processed differently depending on the number of recorded programs.

Meanwhile, a validity period may be specified in the encryption code stored on the storage medium 13 or in the memory. Based on the encryption code, the validity period may not be applied to the playback of a recorded program, but may be applied only to the recording of the anti-copy program. As an alternative example, a period for which the recorded program can be played may be restricted based on the encryption code by specifying a second validity period in the encryption code.

Furthermore, the validity period is specified by the server 300 when the encryption code is transmitted from the server 300, and may be extended by the server 300 at a user's request when the validity period is about to terminate.

Therefore, in the case where a user requests the recording of the anti-copy program, the controller 14 may check whether the current time, which is managed using a timer in the video apparatus 100 or is detected from a broadcast signal received from the tuner/BS processor 11, is included in the validity period, and may record a requested copy-never program on the storage medium 13 using the encryption code that has already been stored.

Furthermore, if the current time exceeds the validity period, the controller 14 asks a user whether to newly update the assigned encryption code and/or the validity period by displaying a message to the user, and performs the series of operations described above (steps S10 to S17) according to the user's selection.

As an alternative embodiment, information about the right to record may be provided through a broadcast signal. If the request for the right to record an anti-copy program is transmitted from the video apparatus 100 to the server 300 along with the identification information (a smart card number, a serial number, an ID, or the like) of a corresponding device, the identification information is added to the broadcast signal of a corresponding program or a channel via which a corresponding program is provided, and is then transmitted.

If the identification information detected from the broadcast signal by the tuner/BS processor 11 is identical to that of a corresponding device, the controller 15 of the video apparatus 100 may generate an encryption code based on the identification information, change the anti-copy program to a copy-once program based on the encryption code, and record the resulting program on the storage medium 13, by controlling the CAS.

As described above, a user can record an anti-copy program and play back the anti-copy program at a later time. Furthermore, a user can record an anti-copy program, which is copyright-protected, while efficiently preventing the anti-copy program from being copied without permission. Furthermore, a content provider is provided with a model for ensuring profits based on the provision of content.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling recording of a program, comprising the steps of:
being assigned a right to record an anti-copy program after performing user authentication;
changing the anti-copy program to a copy-once program using the right to record, and recording the copy-once program on a storage medium; and
transmitting information about the recorded program to a server so that fees corresponding to the recording can be processed in the server.

2. The method as set forth in claim 1, wherein the right to record includes an encryption code that is generated based on identification information of a recording apparatus.

3. The method as set forth in claim 2, wherein the encryption code is generated and provided by the server.

4. The method as set forth in claim 1, wherein:
identification information of a recording apparatus to which the right to record will be assigned is transmitted via a broadcast signal of the anti-copy program or a broadcast signal of a channel via which the anti-copy program is provided; and
the recording apparatus generates an encryption code corresponding to the right to record based on the identification information.

5. The method as set forth in claim 2 or 4, wherein the identification information is a smart card number mounted in the apparatus, or is a serial number of the apparatus.

6. The method as set forth in claim 2 or 4, wherein:
the anti-copy program is scrambled through the encryption code and recorded on a storage medium; and
the anti-copy program recorded on the storage medium is played using the encryption code.

7. The method as set forth in claim 1, wherein the right to record is assigned for a validity period.

8. The method as set forth in claim 7, wherein the validity period is not applied to playing of a program recorded based on the right to record.

9. The method as set forth in claim 7, further comprising the step of extending the validity period through communication with the server.

10. The method as set forth in claim 1, wherein the information about the recorded program is transmitted whenever recording of the corresponding program is terminated, or is transmitted along with information about other recorded programs on a specific date.

11. The method as set forth in claim 1, wherein the storage medium comprises at least one of a hard disk, an optical disk and flash memory.

12. The method as set forth in claim 1, wherein, when the anti-copy program is recorded in a detachable storage medium, a separation type medium content protection technology is further applied to the recording.

13. A program playing and recording apparatus, comprising:
a storage medium for storing a program;
a recording/playing unit for recording or playing a program;
a communication interface unit connected to an external server; and
a controller for controlling the communication interface unit so as to perform a user authentication procedure with the server, the play/recording unit so as to change an anti-copy program to a copy-once program based on an assigned right to record an anti-copy program and to record the resulting program on the storage medium, and the communication interface unit so as to transmit information about the recorded program so that fees corresponding to the recording can be processed in the server in a case where the anti-copy program is recorded.

14. The program playing and recording apparatus as set forth in claim 13, wherein the right to record includes an encryption code that is generated and provided by the server based on identification information of the apparatus.

15. The program playing and recording apparatus as set forth in claim 13, further comprising a broadcast signal processor for processing a broadcast signal,
wherein the broadcast signal processor receives identification information of a corresponding apparatus from a broadcast signal of the anti-copy program and/or a broadcast signal of a channel via which the program is provided, and.
wherein the recording/playing unit generates an encryption code corresponding to a right to record based on the received identification information.

16. The program playing and recording apparatus as set forth in claim 14 or 15, wherein the recording/playing unit scrambles the anti-copy program and records the scrambled program on the storage medium, or plays the anti-copy program recorded on the storage medium, using the encryption code.

17. The program playing and recording apparatus as set forth in claim 13, wherein:
the right to record is assigned for a validity period; and
the validity period is not applied to playing of a program recorded using the right to record.

18. The program playing and recording apparatus as set forth in claim 13, wherein the controller performs control so that the information about the recorded program is transmitted whenever recording of a corresponding program is terminated, or is transmitted along with information about other recorded programs on a specific date.

19. The program playing and recording apparatus as set forth in claim 13, wherein the storage medium comprises at least one of a hard disk, an optical disk and flash memory.

20. The program playing and recording apparatus as set forth in claim 13, wherein the apparatus comprises anyone of a TV, an optical disk recording device, a digital multimedia broadcasting player, a mobile communication terminal, and a portable multimedia player.
